(19) United States
(12) Patent Application Publication
(10) Pub. No.: US 2021/0119319 A1
(43) Pub. Date: Apr. 22, 2021

(54) CONTROLLABLE MULTI-AXIS ANTENNA MOUNT FOR USE ON AERIAL VEHICLES

(71) Applicant: HONEYWELL INTERNATIONAL INC., Morris Plains, NJ (US)

(72) Inventor: Adam Hamada, Gloucestershire (GB)

(21) Appl. No.: 16/657,866

(22) Filed: Oct. 18, 2019

(51) Int. Cl. H01Q 1/18; H01Q 3/00; H01Q 1/12; H01Q 1/28; H04B 17/318

(52) U.S. Cl. CPC H01Q 1/185; H01Q 3/005; H04B 17/318; H01Q 1/28; H01Q 1/1257

(57) ABSTRACT

The present disclosure relates to a controllable multi-axis antenna mount, comprising a gyroscope, a servo, and an antenna mount attachable to an antenna. A control system is configured to stabilize the antenna such that the antenna is directed at a fixed coordinate location regardless of the orientation of the controllable multi-axis antenna mount. In an exemplary embodiment, responsive to movement of the antenna away from the fixed coordinate location caused by the movement of the aerial vehicle during flight, the controllable multi-axis antenna mount utilizing each of the servo and the gyroscope automatically changes the orientation of the antenna to remain directed at the fixed coordinate location.

### TECHNICAL FIELD

This disclosure relates to a controllable multi-axis antenna mount for use with aerial vehicles.

### BACKGROUND

Conventional antennas are permanently affixed to a structure such that the antenna is directed at a desired location and remains in place for a long duration. In such arrangements, when an antenna moves away from the source of the signal, the signal decays and can be lost altogether. Decay and loss of signal result in poor performance and interruption of the usefulness of the signal. As such, conventional antennas are not reliable for applications in aerial vehicles due to possible changes in orientation or other motions during flight.

### SUMMARY

Embodiments of the present disclosure are directed to a controllable multi-axis antenna mount, comprising a gyroscope, a servo, and an antenna mount attachable to an antenna. A control system is configured to stabilize the antenna such that the antenna is directed at a fixed coordinate location regardless of the orientation of the controllable multi-axis antenna mount.

In embodiments, the control system steers the antenna to point at a fixed coordinate location during an aerial vehicle flight, by way of the controllable multi-axis antenna mount. In embodiments, the controllable multi-axis antenna mount is electrically coupled to one or more of the servo or the gyroscope and movably adjustable in at least one of an X-axis, a Y-axis, or a Z-axis direction during the aerial vehicle flight. In embodiments, the controllable multi-axes antenna mount is movably adjustable by adjusting the servo position (e.g., which controls the antenna orientation) in response to signals or commands from one or more of the gyroscope or the control system. In embodiments, the fixed coordinate is associated with a satellite in orbit. In other embodiments, the fixed coordinate may be associated with a ground satellite or signal source.

Systems and computer program products corresponding to the above-summarized methods are also described and claimed herein.

Additional features and advantages are realized through the techniques of the present disclosure. Other embodiments and aspects of the disclosure are described in detail herein and are considered a part of the claimed disclosure. For a better understanding of the disclosure with advantages and features, refer to the description and to the drawings.

### BRIEF DESCRIPTION OF THE FIGURES

The subject matter which is regarded as the disclosure is particularly pointed out and distinctly claimed in the claims at the conclusion of the specification. The foregoing and other objects, features, and advantages of the disclosure are apparent from the following detailed description taken in conjunction with the accompanying drawings in which:

FIG. 1 illustrates an exemplary multi-axis antenna mount, according to embodiments of the present disclosure;

FIG. 2 illustrates exemplary positionings of a multi-axis antenna in the X-axis, Y-axis, and Z-axis directions, according to embodiments of the present disclosure;

FIG. 3 illustrates a block diagram of an exemplary control system, according to embodiments of the present disclosure; and

FIGS. 4A, 4B, and 4C illustrate processes for adjusting an orientation of a multi-axis antenna during aerial vehicle flight, according to embodiments of the present disclosure.

The detailed description explains the preferred embodiments of the disclosure, together with advantages and features, by way of example with reference to the drawings.

### DETAILED DESCRIPTION

An advantage in the present disclosure is that a controllable multi-axis antenna mount can be configured to hold the antenna directed at the fixed coordinate location by movably adjusting the position of the antenna in at least one of an X-axis, a Y-axis, or a Z-axis direction during the aerial vehicle flight, by way of at least one servo in response to signals or commands from a gyroscope or the microcontroller.

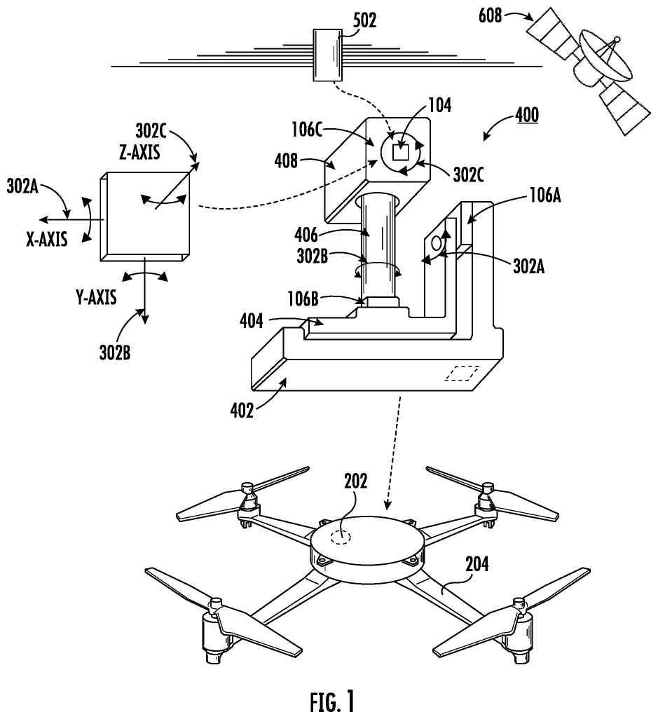

FIG. 1 illustrates an exemplary controllable multi-axis mount according to embodiments of the present disclosure. In an exemplary embodiment, a controllable multi-axis antenna mount 400 can be secured to an aerial vehicle 204. The controllable multi-axis antenna mount 400 can be fabricated from light-weight materials as to not encumber the lifting capabilities of the aerial vehicle 204. In this regard, such light-weight materials can be aluminum, plastic, or other suitable materials, as may be required and/or desired in a particular embodiment.

The aerial vehicle can further comprise an aerial control system 202. The aerial vehicle control system 202 provides the operational controls and function necessary to operate the aerial vehicle 202. Such an aerial control system 202 is coupled to the aerial vehicle 204 connecting the aerial vehicle motors and other controls. The aerial vehicle 204 can also be electrically coupled to and communicate with the microcontroller 102. In this regard, the aerial vehicle control system 204 can provide data and signals to the microcontroller 102 that can be used in determining where to point the antenna 502.

The microcontroller 102 is configured to stabilize the antenna such that the antenna is directed at a fixed coordinate location (such as, e.g., satellite 608 in orbit) regardless of the orientation of the controllable multi-axis antenna mount 400. The microcontroller 102 is responsive to position signals received from the aerial vehicle 204, by way of the aerial vehicle controls 202. Such response to received position signals can be used to translate the position signals into coordinates to which the antenna 502 may be orientated or steered, as required, to point at the desired fixed coordinate location 604 or 606.

The microcontroller 102 can be electrically coupled to a servo 106. For purposes of the present disclosure, in an exemplary embodiment, more than one servo 106 can be used and as such can be referred to as an X-axis servo 106A, a Y-axis servo 106B, and when antenna 502 needs to be rotated about the Z-axis, a Z-axis servo 106C. In embodiments, the servo (or multiple servos) are brushless and are adjusted with a high frequency (e.g., at least 1000× per second or more).

The microcontroller 102 is also electrically coupled to a control system antenna 108. In an exemplary embodiment, the control system antenna 108 receives signals or commands from a remote control separate from the aerial vehicle 204. In this regard, signals or commands such as the fixed coordinate location 608 (such as, e.g., satellite 608 in orbit) can be communicated to the microcontroller 102.

The controllable multi-axis antenna mount 400 can comprise a gyroscope 104. Such a gyroscope 104 can comprise a multi-axis gyroscope X-axis, Y-axis, and (if needed in an exemplary embodiment) Z-axis as illustrated in FIG. 1. The gyroscope 104 can be located on the controllable multi-axis antenna mount 400 in a manner where the rotational motion along each of the axes of interest can be measured by the gyroscope.

In embodiments, to monitor the X-axis, Y-axis, and Z-axis the gyroscope 104 can be located in the antenna mount 408 also referred to as the Z-axis arm 408 and be configured to rotate with the Z-axis 302C. In other embodiments, to monitor the X-axis and the Y-axis together the gyroscope 104 can be located with the Y-axis arm 406. As a further example, to monitor the X-axis alone the gyroscope 104 can be located with the X-axis arm 404.

In an exemplary embodiment, each of the X-axis, the Y-axis, and the Z-axis of the controllable multi-axis antenna mount 400 are independently adjustable by a dedicated servo 106. In this regard, an X-axis servo 106A can be positioned on the controllable multi-axis antenna mount 400 to rotate the antenna 502 around the X-axis 302A. In addition, a Y-axis servo 106B can be positioned on the controllable multi-axis antenna mount 400 to rotate the antenna 502 around the Y-axis 302B. Furthermore, a Z-axis servo 106C can be positioned on the controllable multi-axis antenna mount 400 to rotate the antenna 502 around the Z-axis 302C.

The microcontroller 102 can receive a signal strength indicator related to the antenna 502 performance. Such a signal strength indicator either indicates the strength of the signal being received if the antenna 502 is a receiving signal antenna or indicates the strength of the signal being transmitted from the antenna 502 and received at a remote location if the antenna 502 is a transmitting antenna.

In an exemplary embodiment, responsive to the signal strength indicator interruption or decrease indicating a weak signal, the orientation of the antenna 502 can be automatically changed while pointing at the fixed coordinate location 604 or 606, seeking an antenna 502 orientation in which the signal strength indicator indicates the antenna is receiving a stronger signal.

In an exemplary embodiment, when the antenna 502 needs to be rotated about the Z-axis 302C to properly point the antenna 502, the servo 106C can be configured to circularly rotate the antenna 502 around the Z-axis 302C while pointing at the fixed coordinate location 604 or 606.

In another exemplary embodiment, a controllable multi-axis antenna mount 400, comprises a gyroscope 104, a servo 106, an antenna mount 408 attachable to an antenna 502 and affixed to an aerial vehicle 204, and a microcontroller 102. The antenna 502 can be steered to point at a fixed coordinate location 608 (such as, e.g., satellite 608 in orbit) during the aerial vehicle 204 flight, by way of the controllable multi-axis antenna mount 400. The controllable multi-axis antenna mount 400 is electrically coupled to the servo 106 and the gyroscope 104. The antenna mount is movably adjustable in at least one of an X-axis 302A, a Y-axis 302B, or a Z-axis 302C direction during the aerial vehicle 204 flight. The antenna mount can be repositioned by way of adjusting one or more of the servo 106 positions. The servo 106 controls the antenna 502 orientation in response to signals or commands from the gyroscope 104 or the control system 120.

In an additional exemplary embodiment, a controllable multi-axis antenna mount 400, comprises at least one of a gyroscope 104, at least one of a servo 106 an antenna mount 408 attachable to an antenna 502 and affixed to an aerial vehicle 204, and a microcontroller 102. The antenna 502 is steered to point at a fixed coordinate location 604 during the aerial vehicle 204 flight, by way of the controllable multi-axis antenna mount 400. The controllable multi-axis antenna mount 400 is electrically coupled to one or more of the servo 106 and one or more of the gyroscope 104. Responsive to movement of the antenna 502 away from the fixed coordinate location 604 caused by movement of the aerial vehicle 204 during flight, the controllable multi-axis antenna mount 400 utilizing the servo 106 and the gyroscope 104 automatically changes the orientation of the antenna 502 to maintain pointing at the fixed coordinate location 604.

In another exemplary embodiment, a controllable multi-axis antenna mount 400 can comprise a vehicle mount 402 which can be secured to an aerial vehicle 204. An X-axis arm 404 is secured to a first servo 106A and the first servo 106A is secured to the vehicle mount 402. The X-axis arm 404, by way of the first servo 106C, is rotatable about an X-axis 302C. A Y-axis arm 406 is secured to a second servo 106B and the second servo 106B is secured to the X-axis arm 404. The Y-axis arm 406, by way of the second servo 106B, is rotatable about a Y-axis 302C. An antenna mount 408 is attachable to an antenna 502.

Continuing, the antenna mount 408 can be secured to the third servo 106C and the third servo 106C can be secured to the Y-axis arm 406. The antenna mount 408, by way of the third servo 106C, is rotatable about a Z-axis 302C.

As an alternative exemplary embodiment, the antenna 503 can be secured to the Y-axis arm 406. This embodiment can be useful when the antenna mount 408 is not required. This can be the case when there is no need to rotate the antenna 502 about the Z-axis 302C.

In an exemplary embodiment, the gyroscope 104 can be affixed to the antenna mount 408. The gyroscope 104 is rotatable in the Z-axis 302C direction. This configuration allows a multi-axis gyroscope to monitor the X-Axis 302A, Y-axis 302B, and Z-axis 302C axes from a single location on the controllable multi-axis antenna mount 400. In an alternative embodiment, a multi-axis gyroscope can be located with the Y-axis arm 406 and monitor only the X-Axis 302A and Y-axis 302B. In another alternative embodiment, each of the X-axis 302A, the Y-axis 302B, and the Z-axis 302C of the controllable multi-axis antenna mount 400 can each be independently monitored by a dedicated gyroscope 104.

In operation, a microcontroller 102 can be configured to stabilize an antenna 502 such that the antenna 502 is directed at a fixed coordinate location 608 (such as, e.g., satellite 608 in orbit) regardless of the orientation of the controllable multi-axis antenna mount 400. The antenna is secured to either the Y-axis arm 406 or if present the Z-axis arm 408.

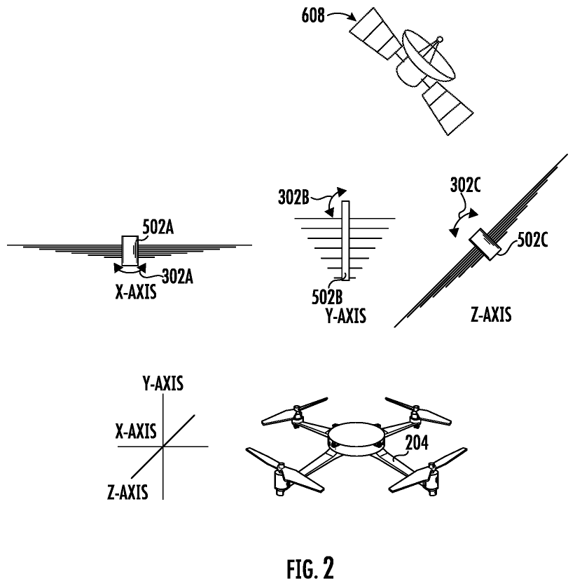

Referring to FIG. 2, exemplary positioning of the antenna 502 is illustrated in the X-axis 302A, Y-axis 302B, and Z-axis 302C directions. With reference to the aerial vehicle 204 and the terrestrial 600 locations shown, antenna 502A illustrates directionally panning back-and-forth along the X-axis 302A. Continuing, antenna 502B illustrates directionally panning up towards the aerial vehicle or celestial locations and down towards terrestrial locations along the Y-axis 302B. Finally, the antenna 502C illustrates rotating around the Z-axis 302C.

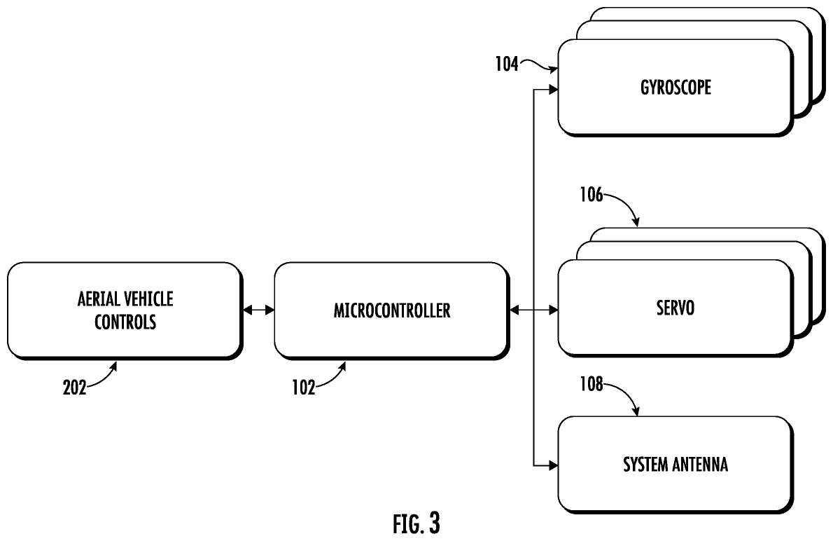

FIG. 3 illustrates a block diagram of an exemplary control system, according to embodiments of the present disclosure. In an exemplary embodiment, a microcontroller 102 can be electrically coupled to a gyroscope 104, a servo 106, and a control system antenna 108. In addition, the microcontroller 102 can also be electrically coupled to the aerial vehicle controls 202.

The microcontroller 102 can be implemented using an INTEL, ZILOG, MICROCHIP, ARM core, or other brands of microcontrollers, as may be required and/or desired in a particular embodiment. Such microcontrollers can have memory resident within or have access to external memory where instructions can be encoded that when executed by the microcontroller perform the methods and facilitate the capabilities of the present disclosure.

In a plurality of exemplary embodiments, a single multi-axis gyroscope 104 can be used to monitor the X-axis, Y-axis, and selectively, as needed, the Z-axis. Alternatively, each of the X-axis, the Y-axis, and the Z-axis of the controllable multi-axis antenna mount 400 can be independently monitored by a dedicated gyroscope 104. In a plurality of other exemplary embodiments, other combinations, quantity, and locations of the gyroscope 104 on the controllable multi-axis antenna mount 400 can be utilized, as may be required and/or desired in a particular embodiment. The gyroscope 104 can be an INVENSENSE, ANALOG DEVICES, MURATA, ADAFRUIT, or other gyroscope brands, as may be required and/or desired in a particular embodiment.

The servo 106 can be a HOBBY PORTER, EMAX, FRSKY, FATSHARK, or other brands of servos, as may be required and/or desired in a particular embodiment.

In operation, in an exemplary embodiment, the controls system can steer the antenna 502 to point at a fixed coordinate location 608 (such as, e.g., satellite 608 in orbit) during the aerial vehicle 204 flight by way of the controllable multi-axis antenna mount 400. The control system is electrically coupled to one or more of the servo 106 and one or more of the gyroscope 104 and movably adjustable in at least one of an X-axis 302A, a Y-axis 302B, or a Z-axis 302C direction during the aerial vehicle 204 flight by adjusting the servo 106 position which control the antenna 502 orientation in response to signals or commands from the gyroscope 104 or the microcontroller 102.

In an exemplary embodiment, the aerial vehicle controls 202 is part of the aerial vehicle 204 and communicate with the microcontroller 102. In this regard, the microcontroller 102 can be responsive to position signals received from the aerial vehicle 204. Such response to received signals can be to translate the signals into where to orientate or steer the antenna 502, as required, to point at the desired fixed coordinate location 604 or 606.

In another exemplary embodiment, the microcontroller 102 can receive commands from a remote control separate from the aerial vehicle 204. In this regard, commands can be sent from terrestrial or celestial locations to the controls system 102 being received at the control system antenna 108.

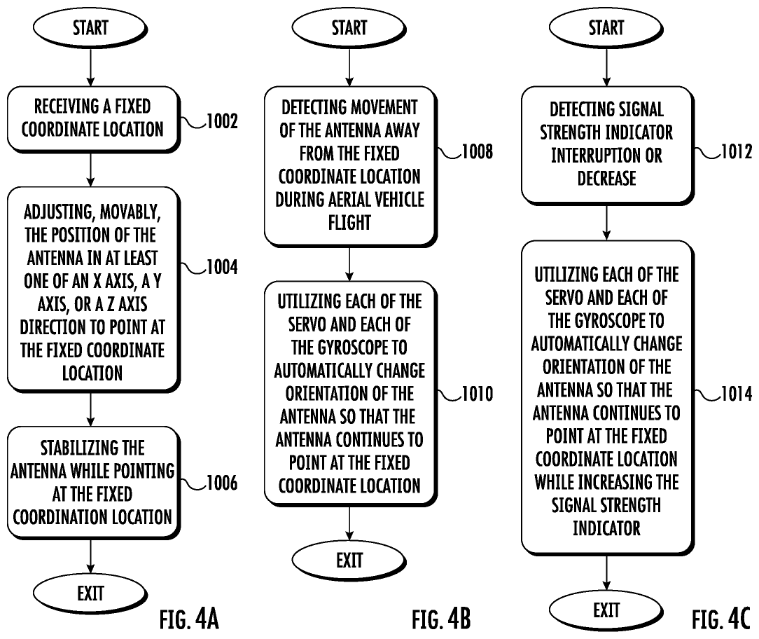

FIGS. 4A, 4B, and 4C illustrate exemplary embodiments of a method of adjusting the orientation of an antenna during aerial vehicle flight.

Referring to FIG. 4A, a method starts in block 1002 where a fixed coordinate location 608 (such as, e.g., satellite 608 in orbit) is received. In an exemplary embodiment, such fixed coordinate location 608 (such as, e.g., satellite 608 in orbit) can be programmed into the aerial vehicle controls 202 or programmed into the microcontroller 102. Alternatively, the fixed coordinate location 608 (such as, e.g., satellite 608 in orbit) can be communicated to the aerial vehicle 204, aerial vehicle controls 202, or the microcontroller 102, by way of a remote control 608.

In block 1004, the controllable multi-axis antenna mount 400 is configured to hold the antenna 502 directed at the fixed coordinate location 608 (such as, e.g., satellite 608 in orbit) by movably adjusting the position of the antenna 502 in at least one of an X-axis 302A, a Y-axis 320B, or a Z-axis 302C direction during the aerial vehicle 204 flight, by way of the servo 106 in response to signals or commands from the gyroscope 104 or the microcontroller 102. The method moves to block 1006.

In block 1006, the antenna 502 can be stabilized such that the antenna is directed at the fixed coordinate location 608 (such as, e.g., satellite 608 in orbit) regardless of the orientation of the controllable multi-axis antenna mount 400.

Referring to FIG. 4B, in block 1008, movement of the antenna 502 away from the fixed coordinate location 608 (such as, e.g., satellite 608 in orbit) caused by the movement of the aerial vehicle 204 during flight is detected.

In block 1010, the controllable multi-axis antenna mount 400 utilizes each of the servos 106 and each of the gyroscopes 104 to automatically change the orientation of the antenna 502 to remain directed at the fixed coordinate location 608 (such as, e.g., satellite 608 in orbit).

Referring to FIG. 4C, in block 1012 a signal strength indicator interruption or decrease (e.g., indicating a weak signal) is detected.

In block 1014, the controllable multi-axis antenna mount 400 utilizes each of the servos 106 and each of the gyroscopes 104 to automatically change the orientation of the antenna 502, seeking an antenna 502 orientation in which the signal strength indicator indicates the antenna 502 is receiving a stronger signal. It will be appreciated that a signal strength indicator can be important in various embodiments because a satellite in orbit does not usually remain at fixed coordinates. Rather, a satellite in orbit oscillates around. Accordingly, tracking the signal strength and attempting to direct the antenna as accurately as possible toward the satellite are closely related or coupled.

In an exemplary embodiment, the control system receives a signal strength indicator related to the antenna performance. Responsive to the signal strength indicator interruption or decrease indicating a weak signal, the orientation of the antenna 502 can be automatically changed while pointing at the fixed coordinate location 608 (such as, e.g., satellite 608 in orbit), seeking an antenna 502 orientation in which the signal strength indicator indicates the antenna is receiving a stronger signal.

The capabilities of the present disclosure can be implemented in software, firmware, hardware or some combination thereof.

As one example, one or more aspects of the present disclosure can be included in an article of manufacture (e.g., one or more computer program products) having, for instance, computer usable media. The media has embodied therein, for instance, computer readable program code means for providing and facilitating the capabilities of the present disclosure. The article of manufacture can be included as a part of a computer system or sold separately.

Additionally, at least one program storage device readable by a machine, tangibly embodying at least one program of instructions executable by the machine to perform the capabilities of the present disclosure can be provided.

The flow diagrams depicted herein are examples. There may be many variations to these diagrams or the steps (or operations) described therein without departing from the spirit of the disclosure. For instance, the steps may be performed in a differing order, or steps may be added, deleted or modified. All of these variations are considered a part of the claimed disclosure.

While the preferred embodiment to the disclosure has been described, it will be understood that those skilled in the art, both now and in the future, may make various improvements and enhancements which fall within the scope of the claims which follow. These claims should be construed to maintain the proper protection for the disclosure first described.

What is claimed is:

1. A controllable multi-axis antenna mount, comprising:
a gyroscope;
a servo;
an antenna mount attachable to an antenna; and
a control system configured to stabilize the antenna such that the antenna is directed at a fixed coordinate location regardless of orientation of the controllable multi-axis antenna mount.

2. The controllable multi-axis antenna mount in accordance with claim 1, wherein the controllable multi-axis antenna mount is connectable to an aerial vehicle.

3. The controllable multi-axis antenna mount in accordance with claim 2, the control system is responsive to a plurality of position signals received from the aerial vehicle.

4. The controllable multi-axis antenna mount in accordance with claim 2, wherein the controllable multi-axis antenna mount is configured to hold the antenna directed at the fixed coordinate location by movably adjusting a position of the antenna in at least one of an X-axis, a Y-axis, or a Z-axis direction during an aerial vehicle flight, by way of the servo in response to signals or commands from one or more of the gyroscope or the control system.

5. The controllable multi-axis antenna mount in accordance with claim 4, wherein each of the X-axis, the Y-axis, and the Z-axis of the controllable multi-axis antenna mount is independently adjustable by a dedicated servo.

6. The controllable multi-axis antenna mount in accordance with claim 4, wherein each of the X-axis, the Y-axis, and the Z-axis of the controllable multi-axis antenna mount is independently monitored by a dedicated gyroscope.

7. The controllable multi-axis antenna mount in accordance with claim 2, wherein responsive to movement of the antenna away from the fixed coordinate location caused by movement of the aerial vehicle during flight, the controllable multi-axis antenna mount utilizes the servo and the gyroscope to automatically change orientation of the antenna to remain directed at the fixed coordinate location.

8. The controllable multi-axis antenna mount in accordance with claim 2, wherein the control system receives a signal strength indicator related to the antenna performance.

9. The controllable multi-axis antenna mount in accordance with claim 8, wherein responsive to the signal strength indicator interruption or decrease indicating a weak signal, by automatically changing orientation of the antenna while pointing at the fixed coordinate location, the control system seeks an antenna orientation in which the signal strength indicator indicates the antenna is receiving a stronger signal.

10. The controllable multi-axis antenna mount in accordance with claim 2, wherein the control system receives commands from a remote device separate from the aerial vehicle.

11. The controllable multi-axis antenna mount in accordance with claim 2, wherein at the servo is configured to circularly rotate the antenna around the Z-axis while pointing at the fixed coordinate location.

12. A controllable multi-axis antenna mount, comprising:
a gyroscope;
a servo;
an antenna mount attachable to an antenna and affixable to an aerial vehicle; and
a control system configured to point the antenna at a fixed coordinate location during an aerial vehicle flight, wherein the controllable multi-axis antenna mount is electrically couplable to one or more of the servo or the gyroscope and movably adjustable in at least one of an X-axis, a Y-axis, or a Z-axis direction during the aerial vehicle flight by adjusting a servo position which controls an antenna orientation in response to signals or commands from one or more of the gyroscope or the control system.

13. The controllable multi-axis antenna mount in accordance with claim 12, wherein the control system is responsive to a plurality of position signals received from the aerial vehicle.

14. A controllable multi-axis antenna mount, comprising:
a gyroscope;
a servo;
an antenna mount attachable to an antenna and affixable to an aerial vehicle; and
a control system, wherein the antenna is steered to point at a fixed coordinate location during the aerial vehicle flight by way of the controllable multi-axis antenna mount, wherein the controllable multi-axis antenna mount is electrically couplable to one or more of the servo and or the gyroscope and is responsive to movement of the antenna away from the fixed coordinate location caused by movement of the aerial vehicle during flight, and wherein the controllable multi-axis antenna mount utilizes one or more of the servo or the gyroscope to automatically change orientation of the antenna to maintain direction toward the fixed coordinate location.

15. The controllable multi-axis antenna mount in accordance with claim 14, wherein the control system is responsive to a plurality of position signals received from the aerial vehicle.

16. The controllable multi-axis antenna mount in accordance with claim 14, wherein the controllable multi-axis antenna mount is configured to hold the antenna directed at the fixed coordinate location by movably adjusting a position of the antenna in at least one of an X-axis, a Y-axis, or a Z-axis direction during the flight, by way of the servo in response to signals or commands from one or more of the gyroscope or the control system.

17. The controllable multi-axis antenna mount in accordance with claim 14, wherein the servo is configured to circularly rotate the antenna around the Z-axis while pointing the antenna at the fixed coordinate location.

18. A controllable multi-axis antenna mount, comprising:
a vehicle mount securable to an aerial vehicle;
an X-axis arm securable to a first servo, the first servo securable to the vehicle mount, wherein the X-axis arm, by way of the first servo, is rotatable about an X-axis;
a Y-axis arm securable to a second servo, the second servo securable to the X-axis arm, wherein the Y-axis arm, by way of the second servo, is rotatable about a Y-axis; and
an antenna mount attachable to an antenna.

19. The controllable multi-axis antenna mount in accordance with claim 18, further comprising:
a third servo securable to the Y-axis arm, wherein the antenna mount is securable to the third servo, and wherein the antenna mount, by way of the third servo, is rotatable about a Z-axis.

20. The controllable multi-axis antenna mount in accordance with claim 18, wherein the antenna is securable to the Y-axis arm.

21. The controllable multi-axis antenna mount in accordance with claim 19, further comprising:
a gyroscope affixable to the antenna mount, wherein the gyroscope is rotatable in the Z-axis direction.

22. The controllable multi-axis antenna mount in accordance with claim 18, further comprising:
a control system configured to stabilize the antenna such that the antenna is directed at a fixed coordinate location regardless of orientation of the controllable multi-axis antenna mount, wherein the antenna is secured to either the Y-axis arm or the antenna mount.

23. The controllable multi-axis antenna mount in accordance with claim 22, wherein the controllable multi-axis antenna mount is configured to hold the antenna directed at the fixed coordinate location by movably adjusting a position of the antenna in at least one of the X-axis or the Y-axis direction during an aerial vehicle flight, by way of the first servo or the second servo, in response to signals or commands from one or more of the gyroscope or the control system.

24. The controllable multi-axis antenna mount in accordance with claim 22, further comprising:
a third servo secured to the Y-axis arm, wherein the antenna mount is secured to the third servo, wherein the antenna mount, by way of the third servo, is rotatable about the Z-axis.

25. The controllable multi-axis antenna mount in accordance with claim 24, wherein the controllable multi-axis antenna mount is configured to hold the antenna directed at the fixed coordinate location by movably adjusting position of the antenna in at least one of the X-axis, the Y-axis, or the Z-axis direction during the aerial vehicle flight, by way of the first servo, the second servo, or the third servo, in response to signals or commands from one or more of the gyroscope or the control system.
